(19) United States
(12) Patent Application Publication
(10) Pub. No.: US 2026/0079924 A1
(43) Pub. Date: Mar. 19, 2026

(54) DATA STORAGE AND SEARCH FUNCTIONALITY USING HOT AND COLD EMBEDDINGS

(71) Applicant: Level 3 Communications, LLC, Denver, CO (US)

(72) Inventors: Priyadarshini Dande, Thornton, CO (US); David Navarro Estruch, Valencia City (ES)

(73) Assignee: Level 3 Communications, LLC, Denver, CO (US)

(21) Appl. No.: 19/313,211

(22) Filed: Aug. 28, 2025

Related U.S. Application Data
(60) Provisional application No. 63/696,074, filed on Sep. 18, 2024.

(51) Int. Cl. G06F 16/242; G06F 16/22; G06F 16/25

(52) U.S. Cl. CPC G06F 16/243; G06F 16/2237; G06F 16/258

(57) ABSTRACT

Novel tools and techniques are provided for implementing data storage and search functionality using hot and cold embeddings. In examples, a first vector data storage device is implemented to store hot embeddings, which are vector representations of data that has been determined to likely be used within a succeeding timeframe and that is associated with a plurality of network services each of which is one of being provisioned, in a process of being provisioned, or being ordered for provisioning, by a service provider, at a plurality of locations associated with a corresponding plurality of entities. The first vector data storage device is kept up to date with updates to any of the plurality of data. Embeddings of data that has been determined to not likely be used within the succeeding timeframe are moved to a second vector data storage device as cold embeddings.

### CROSS-REFERENCE TO RELATED APPLICATIONS

This application claims the benefit of U.S. Provisional Application No. 63/696,074 filed Sep. 18, 2024, entitled “Data Storage and Search Functionality Using Hot and Cold Embeddings,” which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing data storage and search functionality using hot and cold embeddings.

### BACKGROUND

Generative artificial intelligence (“AI”) systems (such as AI platforms based on large language models (“LLMs”) like Generative Pre-trained Transformer (“GPT”), such as GPT-4, or the like) are extremely powerful tools that can assist in compiling, analyzing, and summarizing data. Such systems, however, are limited by the number of tokens (e.g., basic units of data, including text data, image data, etc.) that the systems are capable of processing at a time (referred to as a context window). Where there is a large number and/or large size of documents, data files, etc. that need to be processed (typically exceeding the size of the context window of an LLM), such as in the ordering and/or provisioning of some network services, a problem arises in the LLMs processing such data in a coherent and integrated manner. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing data storage and search functionality using hot and cold embeddings, in accordance with various embodiments.

FIGS. 2A and 2B depict an example sequence flow for implementing data storage and search functionality using hot and cold embeddings, in accordance with various embodiments.

FIG. 2C depicts an example network service order summary when implementing data storage and search functionality using hot and cold embeddings, in accordance with various embodiments.

FIGS. 3A-3E depict flow diagrams illustrating an example method for implementing data storage and search functionality using hot and cold embeddings, in accordance with various embodiments.

FIGS. 4A-4C depict flow diagrams illustrating another example method for implementing data storage and search functionality using hot and cold embeddings, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

The present technology provides for data storage and search functionality using hot and cold embeddings. In examples, data in the form of textual data, message data, image data, audio data, video data, document data, and/or data files that are accessible by a computing system are initially converted into a plurality of embeddings corresponding to vector representations of the various data, and stored in a hot embeddings vector storage device. The hot embeddings vector storage device is kept up-to-date, by replacing embeddings corresponding to data that has changed with embeddings of the updated data. A semantic index may be created while storing the “hot” embeddings in the hot embeddings vector storage device. Generating embeddings and a semantic index incurs computational and monetary costs, especially if done at each instance that a query to an LLM is made. By maintaining a long-term, persisting, cache-like vector database in the form of the hot embeddings vector storage device that is kept up-to-date and current, such continuing costs can be defrayed, particularly for repeated generation of embeddings and semantic indexes for data that has not changed. Embeddings corresponding to data that is determined to not likely be used within a rolling succeeding timeframe (e.g., within a six month rolling window) may then be moved to a lower cost, long-term vector database (referred to herein as a cold embeddings vector storage device). The hot (and cold) embeddings facilitate processing by the computing system and/or the AI system, due to the vector representations being better understood and processible by such machines. Queries, from a requesting device, to the hot embeddings vector storage device (and, in some cases, to the cold embeddings vector storage device as well) by the AI system (using the prompts to the LLM) that do not return relevant results (or returns messages indicating that the requested information is not found) may be followed up by a search of the original or source data storage devices in at least one network, by the computing system and/or the AI system. The results of such search may be returned to the requesting device and may be converted to embeddings for storage in the hot embeddings vector storage device. In this manner, improved efficiencies in terms of conversions to embeddings, searches, and semantic indexing can be achieved.

In examples, where there is a large number and/or size of the data, dividing the data files into “chunks” (referred to as “chunking”) as part of the embedding and semantic indexing process further improves the efficiency and storage of relevant embeddings, while enabling coherent and integrated processing of such data by LLMs that are limited in terms of context window sizes. Such processing may include generating a summary from a complete collection of all relevant data pertaining to a topic (e.g., ordering and/or provisioning of a network service, particularly, where such provisioning requires obtaining permits from local authorities, communicating with local authorities, coordinating with different parties (e.g., customers, technicians, local authorities, construction personnel, contractors, or other workers, etc.), etc., in addition to installation of equipment for provisioning and configuring the network services).

These and other aspects of the data storage and search functionality using hot and cold embeddings are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system and from a requesting device, a first request for information regarding a first network service that is one of being provisioned, in a process of being provisioned, or being ordered for provisioning, by a service provider, at one or more locations associated with a first entity; querying, by the computing system, a first vector data storage device for stored information regarding the first network service, based on the first request, the first vector data storage device storing a plurality of hot embeddings, the plurality of hot embeddings being vector representations of a corresponding plurality of data that each has a probability exceeding a first threshold probability of being used within a succeeding timeframe and that is associated with a plurality of network services each of which is one of being provisioned, in a process of being provisioned, or being ordered for provisioning, by the service provider, at a plurality of locations associated with a corresponding plurality of entities; and performing, by the computing system, one of a first set of tasks or a second set of tasks. The first set of tasks includes receiving, from the first vector data storage device, first embeddings corresponding to vector representations of first data that are associated with the first network service; converting the first embeddings into second data; and sending the second data to the requesting device, the second data either including at least a portion of the first data or being in a format corresponding to a format of at least a portion of the first data. The second set of tasks includes receiving, from the first vector data storage device, a first message indicating that information regarding the first network service could not be found; generating a first prompt for a private large language model (“LLM”) to provide a summary of data regarding the first network service that is accessed from two or more data storage devices among a plurality of data storage devices in at least one network, the first prompt being generated based on the first request; sending the first prompt as input to the private LLM; receiving the summary from the private LLM; and sending the summary to the requesting device.

In another aspect, the technology relates to a system, including a processing system; and memory coupled to the processing system, the memory including computer executable instructions that, when executed by the processing system, causes the system to perform operations including: receiving, from a requesting device, a first request for information regarding a first network service that is one of being provisioned, in a process of being provisioned, or being ordered for provisioning, by a service provider, at one or more locations associated with a first entity; querying a first vector data storage device for stored information regarding the first network service, based on the first request, the first vector data storage device storing a plurality of hot embeddings, the plurality of hot embeddings being vector representations of a corresponding plurality of data that each has a probability exceeding a first threshold probability of being used within a succeeding timeframe and that is associated with a plurality of network services each of which is one of being provisioned, in a process of being provisioned, or being ordered for provisioning, by the service provider, at a plurality of locations associated with a corresponding plurality of entities; and performing one of a first set of tasks or a second set of tasks. The first set of tasks includes receiving, from the first vector data storage device, first embeddings corresponding to vector representations of first data that are associated with the first network service; converting the first embeddings into second data; and sending the second data to the requesting device, the second data either including at least a portion of the first data or being in a format corresponding to a format of at least a portion of the first data. The second set of tasks includes receiving, from the first vector data storage device, a first message indicating that information regarding the first network service could not be found; generating a prompt for a private LLM to access third data regarding the first network service from two or more data storage devices among a plurality of data storage devices in at least one network and to convert the third data into fourth data, the prompt being generated based on the first request; sending the prompt as input to the private LLM; receiving the fourth data from the private LLM; and sending the fourth data to the requesting device.

In yet another aspect, the technology relates to a method, including receiving, by a computing system and from two or more data storage devices among a plurality of data storage devices in at least one network, first data associated with a first network service that is one of being provisioned, in a process of being provisioned, or being ordered for provisioning, by a service provider, at one or more premises locations associated with a first entity, the first data including at least one of textual data, message data, image data, audio data, video data, document data, or data files collectively having a cumulative size that exceeds a token size of a private LLM; dividing, by the computing system, at least portions of the first data based on one or more of sentences, paragraphs, pages, documents, subject, topic, or relevance to the first network service to produce a plurality of second data; identifying, by the computing system, second data, among the first data, that has a probability exceeding a first threshold probability of being used within a succeeding timeframe; converting, by the computing system, one or more portions of the second data into a corresponding one or more first embeddings each corresponding to a vector representation of one of the one or more portions of the second data; and storing, by the computing system and in a first vector data storage device, the one or more first embeddings as a first set of hot embeddings among a plurality of hot embeddings stored in the first vector data storage device. In response to receiving a request for information regarding the first data, the computing system queries the first vector data storage device for the first set of hot embeddings, prior to attempts at generating and sending a prompt as input to the private LLM to produce data regarding the first network service accessed from the two or more data storage devices.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### SPECIFIC EXEMPLARY EMBODIMENTS

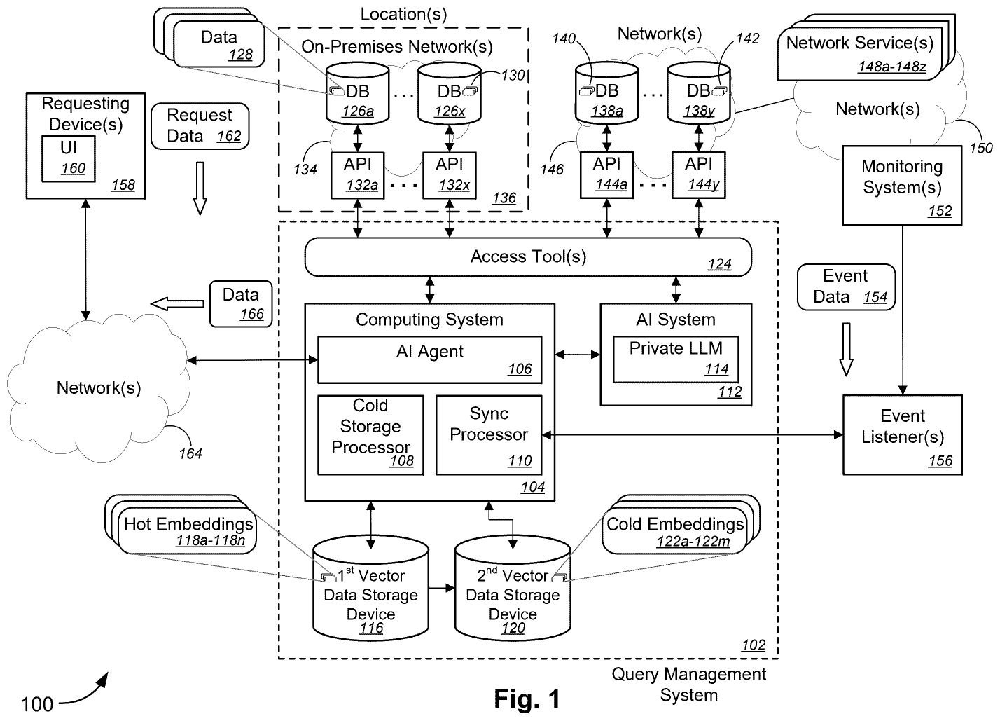

Turning to the embodiments as illustrated by the drawings, FIGS. 1-5 illustrate some of the features of methods, systems, and apparatuses for implementing data storage and search functionality using hot and cold embeddings, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing data storage and search functionality using hot and cold embeddings, in accordance with various embodiments.

In the non-limiting example of FIG. 1, system 100 includes a query management system 102, which may include a computing system 104, which may include an artificial intelligence (“AI”) agent 106, a cold storage processor 108, and/or a synchronization processor 110. System 100 may further include AI system 112, which may be based on a private LLM 114. AI system 112 may also train the private LLM 114, and may use the private LLM 114 for inferencing tasks. As used herein, a private LLM refers to an LLM that is trained on specific, carefully vetted datasets that are controlled to avoid dubious, unreliable, or false information, whereas a public LLM refers to an LLM that is trained based on datasets obtained from the Internet. Security and reliability can be better controlled with a private LLM compared with a public LLM. In some examples, the private LLM 114 includes a private instance of a publicly accessible generative AI model (e.g., a private instance of Generative Pre-trained Transformer (“GPT”), such as GPT-4, or the like).

System 100 may further include a first vector data storage device 116 (also referred to herein as a “hot embeddings vector storage device” or the like) that stores a plurality of hot embeddings 118a-118n (collectively, “hot embeddings 118” or the like) and a second vector data storage device 120 (also referred to herein as a “cold embeddings vector storage device” or the like) that stores a plurality of cold embeddings 122a-122m (collectively, “cold embeddings 122” or the like). In examples, the first vector data storage device 116 may include a retrieval augmented generation (“RAG”) data storage system that is a long-term, persisting, cache-like vector database. System 100 may further include one or more access tools 124, which may include interfaces, connectors, etc.

As used herein, an embedding refers to, or corresponds to, a vector representation of data (such as objects like images, documents, audio clips, video clips, software code, etc.) in a multiple-dimensional vector space. In examples, such data includes textual data, message data, image data, audio data, video data, document data, and/or data files (e.g., JavaScript Object Notation (“JSON”) files, which are open standard file format files and data interchange format files that use human-readable text to store and transmit data objects consisting of attribute-value pairs and arrays). Similar or closely related/relevant objects, when in vector representation, are proximate to each other in the vector space (i.e., within a threshold distance in vector space), while different or unrelated/non-relevant objects, when in vector representation, are farther apart from each other in the vector space (i.e., beyond the threshold distance in vector space). In this way, embeddings may be used to enable machine learning models to find similar objects. For instance, given a photograph or a document, a machine learning model that uses embeddings could find a similar photograph or document, because embeddings make it possible for computers to understand the relationships between words or other objects, thus making embeddings a foundational aspect of AI systems. As used herein, “hot embeddings” refer to embeddings corresponding to data that is likely to be used within a succeeding timeframe or in the next X period, while “cold embeddings” refer to embeddings corresponding to data that is not likely to be used within a succeeding timeframe or in the next X period. Herein, likelihood of being used may refer to a probability exceeding a first threshold probability of being used (e.g., 50, 60, 70, 80%, or greater). Succeeding timeframe or the next X period may refer to, e.g., the next one or more weeks, the next one or more months, the next annual quarter, the next half a year, the next year, or longer.

System 100 may further include a plurality of data storage devices or databases (“DBs”) 126a-126x (collectively, “data storage devices 126” or “DBs 126” or the like), each storing data 128 or 130. The plurality of data storage devices 126 is each accessible by the computing system 104 and/or by the AI system 112, via the one or more access tools 124 and via a corresponding one of a plurality of application programming interfaces (“APIs”) 132a-132x (collectively, “APIs 132” or the like), the plurality of data storage devices 126 being located within on-premises network(s) 134, which is located at location(s) 136. System 100 may further include a plurality of data storage devices or DBs 138a-138y (collectively, “data storage devices 138” or “DBs 138” or the like), each storing data 140 or 142. In some examples, data 128, 130, 140, and/or 142 may each include at least one of textual data, message data, image data, audio data, video data, document data, or data files (e.g., JSON files, etc.), and/or the like. The plurality of data storage devices 138 is each accessible by the computing system 104 and/or by the AI system 112, via the one or more access tools 124 and via a corresponding one of a plurality of APIs 144a-144y (collectively, “APIs 144” or the like), the plurality of data storage devices 138 being located within network(s) 146. System 100 may further include a plurality of network services 148a-1482 (collectively, “network services 148” or the like) that are provided via network equipment in network(s) 150. The plurality of network services 148 are provisioned at the location(s) 136, which is associated with one or more entities among a plurality of entities. Herein, m, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

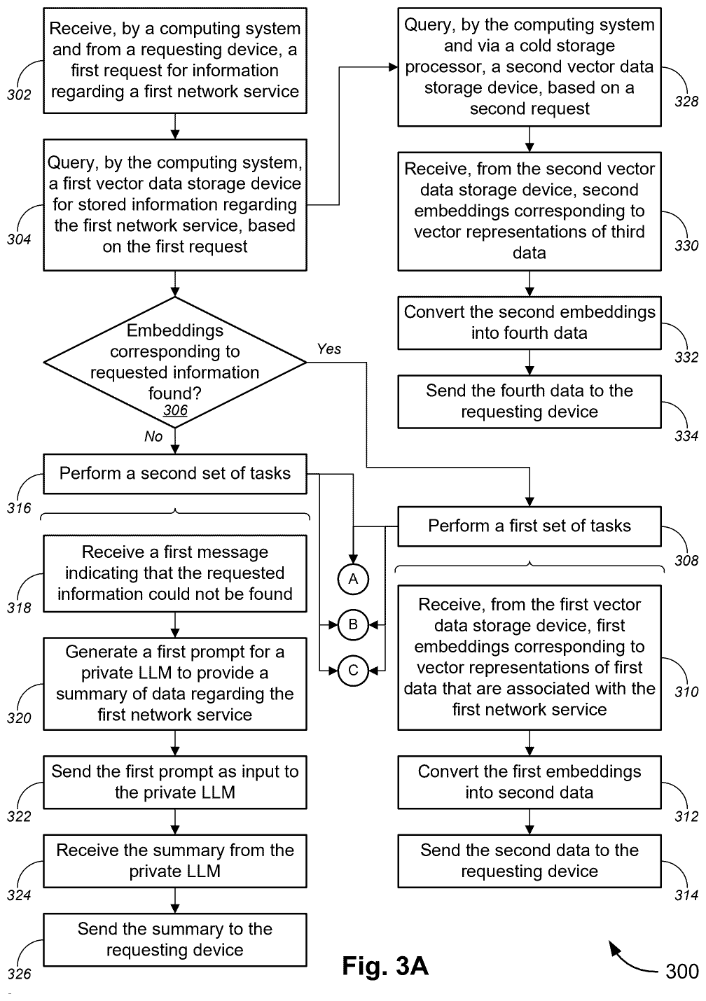

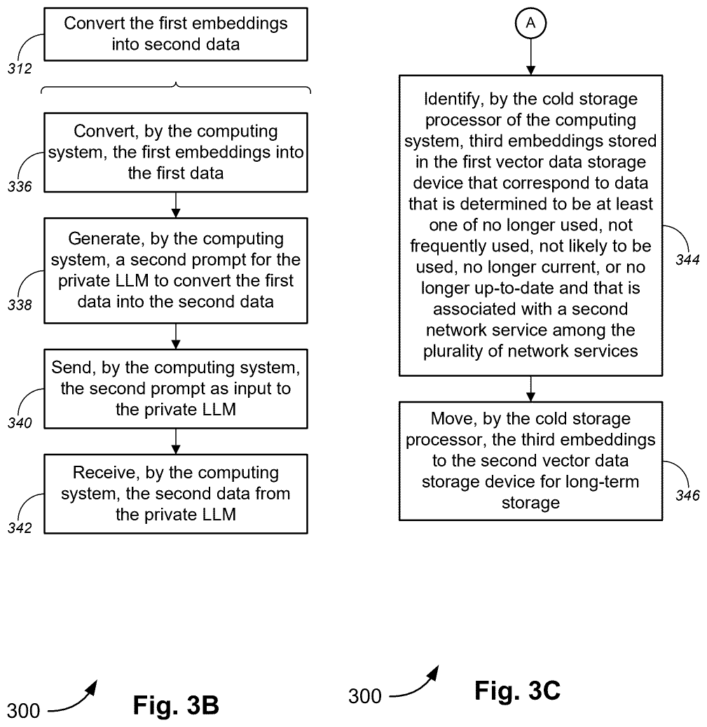

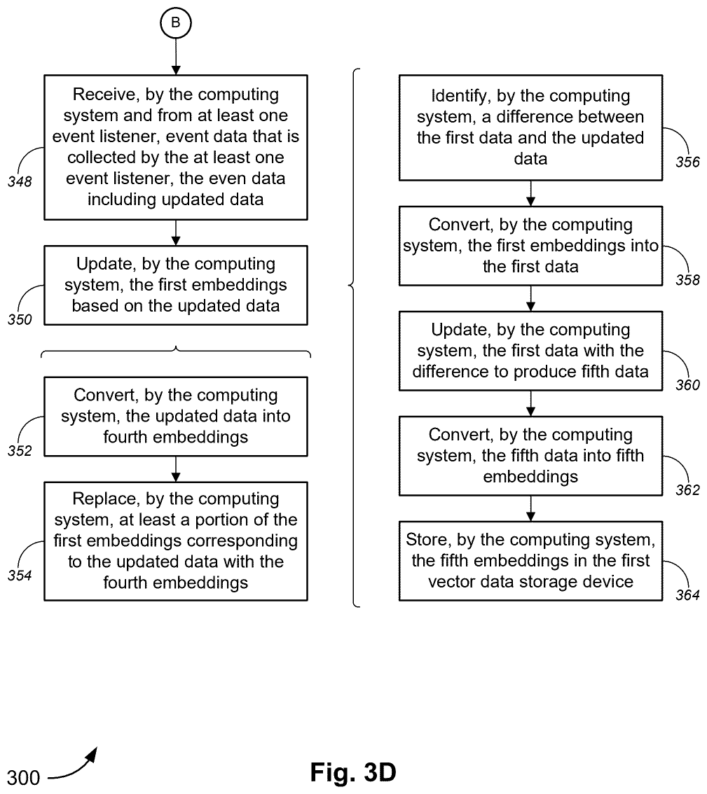

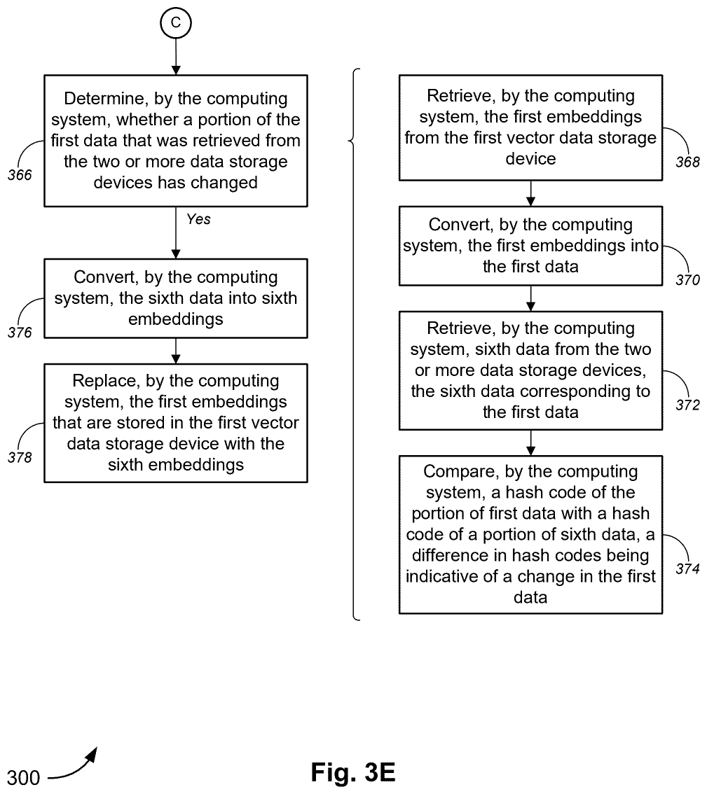

In some examples, the plurality of network services 148 may be monitored by monitoring system(s) 152. Event data 154 that is collected by monitoring system(s) 152 is relayed by event listener(s) 156 to the synchronization processor 110, and any changes to one or more network services among the plurality of network services 148 may be used to update corresponding hot embeddings 118a-118n. FIG. 3D (and corresponding detailed description below) covers an example implementation in which event data collected by an event listener (such as event listener(s) 156) is used to update and/or replace at least portions of embeddings in the first vector data storage device (such as the first vector data storage device 116).

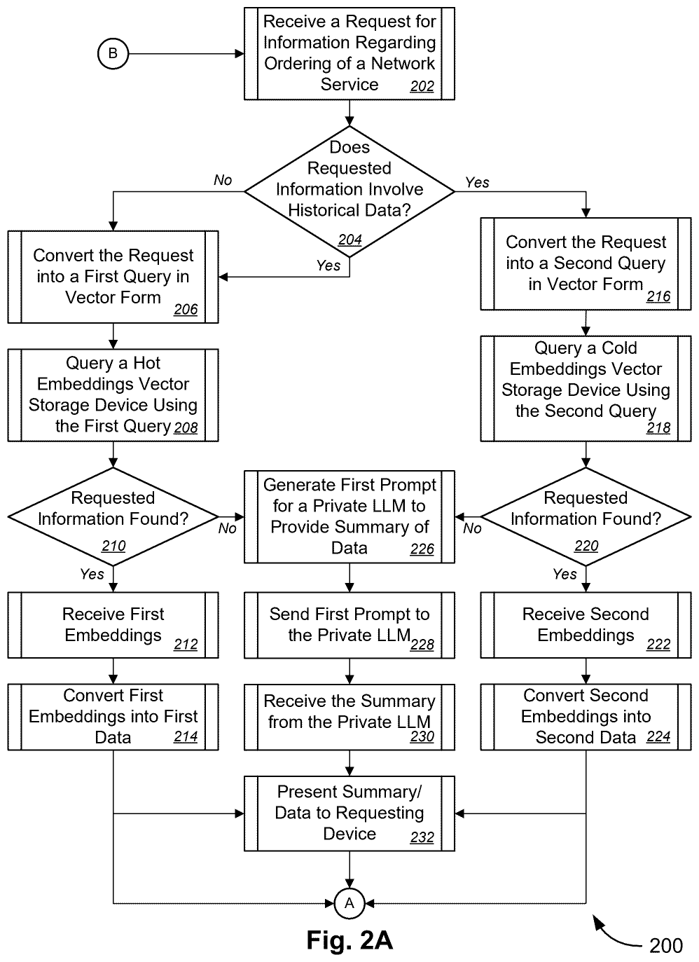

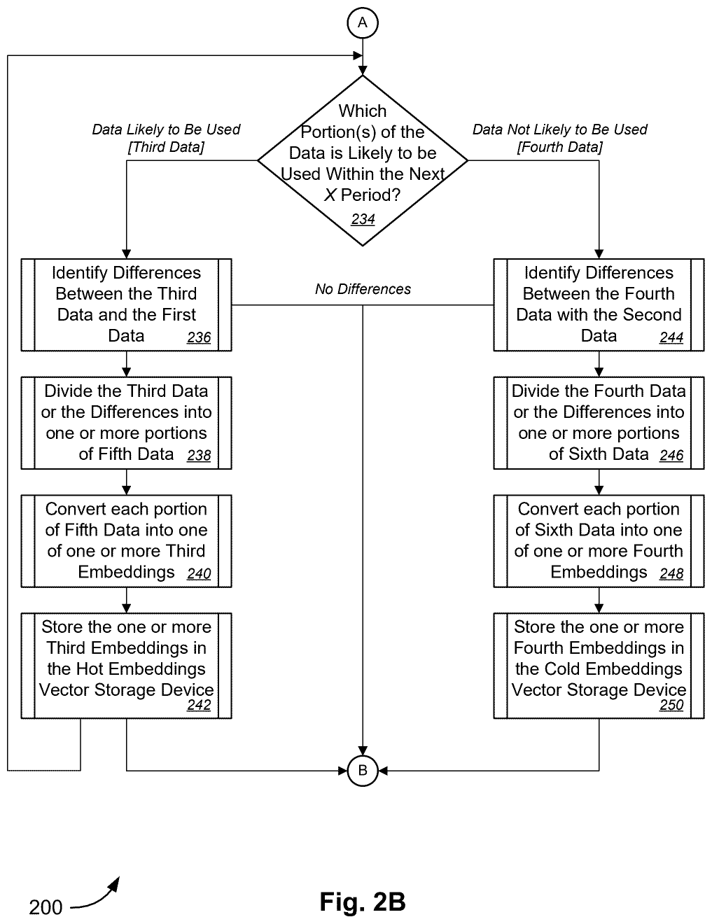

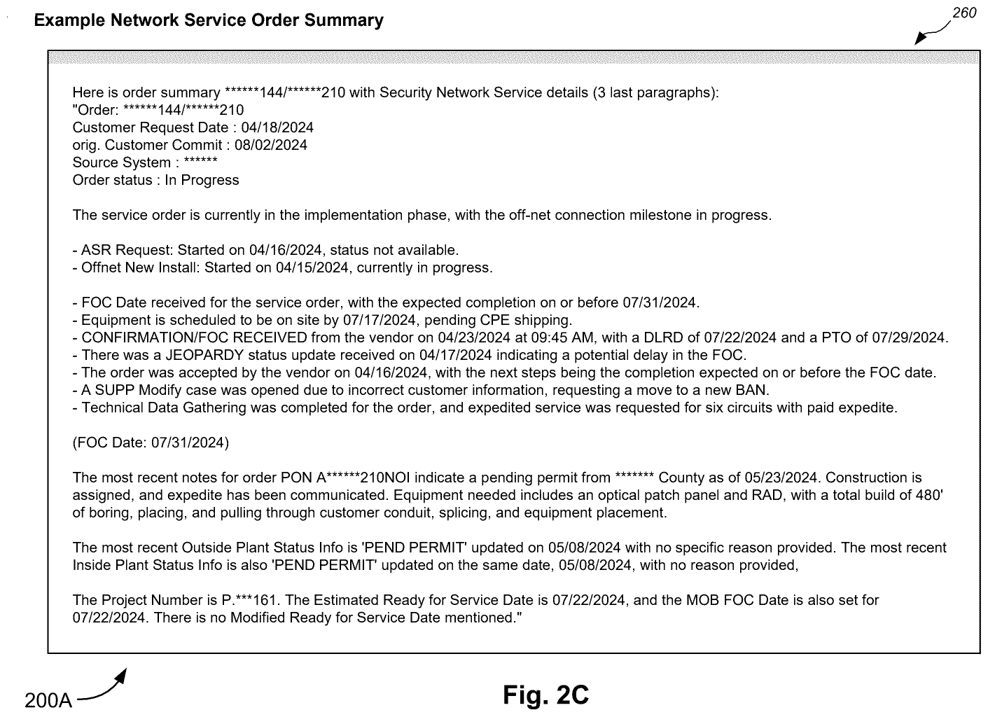

System 100 may further include a requesting device(s) 158, which, via a user interface (“UI”) 160, enables sending of a request 162 for data associated with one of the plurality of network services 148a-148z to computing system 104 (in some cases, to AI agent 106), via network(s) 164. In response to the request 162, computing system 104 returns data 166, in some cases, following the processes and operations as described in detail below (such as in FIGS. 2A-4C below). In some instances, the requesting device(s) 158 may each include, but is not limited to, one of a desktop computer, a laptop computer, a tablet computer, a smart phone, a mobile phone, or a network operations center (“NOC”) computing system or console, and/or the like. The requesting device(s) 158 is each associated with a user including one of a customer care management team, a billing team member, a service delivery team member, an individual corresponding to one of the plurality of entities, or an agent of the first entity, and/or the like.

According to some embodiments, unless otherwise indicated, networks 134, 146, 150, and 164 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 134, 146, 150, and 164 may include an access network of the service provider (e.g., an Internet service provider (“ISP”)). In another embodiment, the networks 134, 146, 150, and 164 may include a core network of the service provider and/or the Internet.

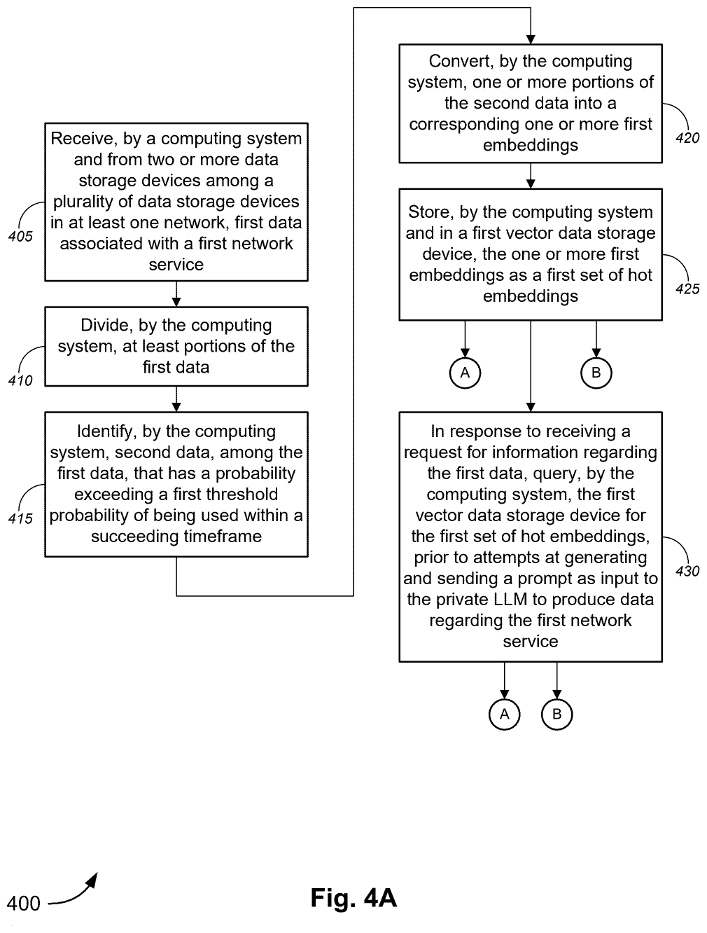

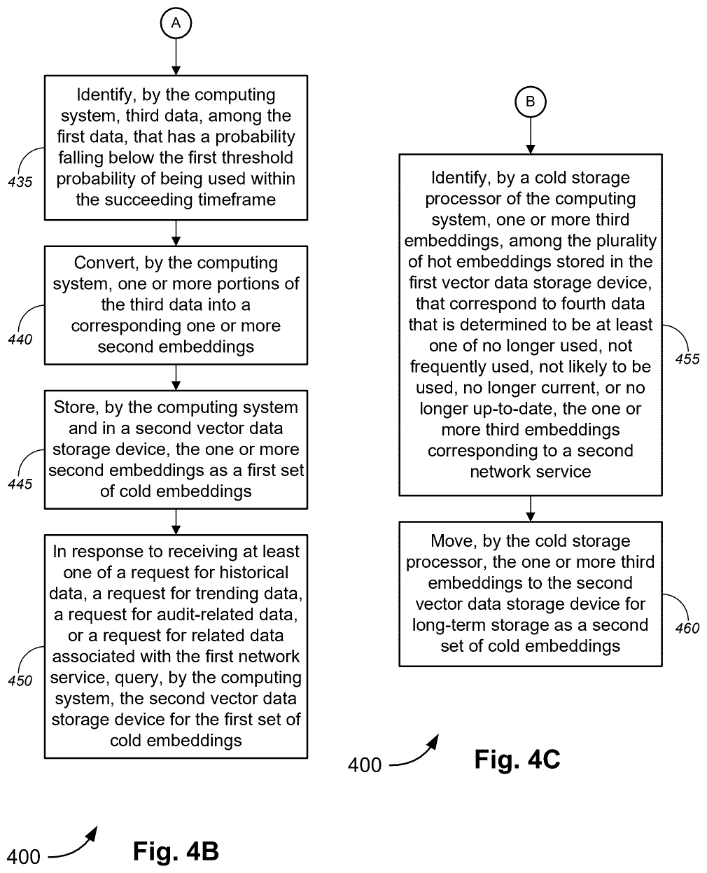

In operation, computing system 104, the AI agent 106, the cold storage processor 108, the synchronization processor 110, and/or the AI system 112 may perform methods for implementing data storage and search functionality using hot and cold embeddings, as described in detail with respect to FIGS. 2A-4C. For example, example sequence flows 200 as described below with respect to FIGS. 2A and 2B, example network service order summary 200A as described below with respect to FIG. 2C, and example methods 300 and 400 as described below with respect to FIGS. 3A-3E and 4A-4C, respectively, may be applied with respect to the operations of system 100 of FIG. 1.

FIGS. 2A and 2B depict an example sequence flow 200 for implementing data storage and search functionality using hot and cold embeddings, in accordance with various embodiments. In examples, the operations referred to in example sequence flow 200 may be performed by a computing system (e.g., computing system 104 of FIG. 1 (or its components)). FIG. 2C depicts an example network service order summary 200A when implementing data storage and search functionality using hot and cold embeddings, in accordance with various embodiments.

With reference to FIG. 2A, a computing system receives, from a requesting device (e.g., requesting device(s) 158 of FIG. 1, or the like), a request for information regarding ordering of a network service (at operation 202). The computing system determines whether the requested information involves historical data (at operation 204), in some cases, determining whether the request includes at least one of a request for historical data, a request for trending data, a request for audit-related data, or a request for related data associated with the first network service, and/or the like. Based on a determination that the requested information involves historical data, the sequence flow 200 continues onto the process at operation 216, and, in some cases, onto the process at 206 as well (particularly for requests involving current and historical data, such as requests for trending data or audit-related data, and the like). Based on a determination that the requested information does not involve historical data (i.e., involves current data, etc.), the sequence flow 200 continues onto the process at operation 206.

At operation 206, the computing system converts the request into a first query in vector form, in some cases, by converting the first query into first search embeddings. The computing system, at operation 208, queries a hot embeddings vector storage device (e.g., the first vector data storage device 116 of FIG. 1, or the like) using the first query (in applicable cases, using the first search embeddings). It is determined, at operation 210, whether the requested information was found in the hot embeddings vector storage device, in some cases, by searching for hot embeddings within the vector space that are proximate to the first search embeddings. Based on a determination that the requested information was found in the hot embeddings vector storage device (e.g., by finding hot embeddings (such as first embeddings) within the vector space that are proximate to the first search embeddings), the sequence flow 200 continues onto the process at operation 212. Based on a determination that the requested information was not found in the hot embeddings vector storage device (e.g., by finding no hot embeddings within the vector space that are proximate to the first search embeddings), the sequence flow 200 continues onto the process at operation 226. At operation 212, the computing system receives the first embeddings from the hot embeddings vector storage device, and converts the first embeddings into first data (at operation 214). The sequence flow 200 either continues onto the process at operation 232 or continues onto the process at operation 234 in FIG. 2B following the circular marker denoted, “A.”

At operation 216, the computing system converts the request into a second query in vector form, in some cases, by converting the second query into second search embeddings. The computing system, at operation 218, queries a cold embeddings vector storage device (e.g., the second vector data storage device 120 of FIG. 1, or the like) using the second query (in applicable cases, using the second search embeddings). It is determined, at operation 220, whether the requested information was found in the cold embeddings vector storage device, in some cases, by searching for cold embeddings within the vector space that are proximate to the second search embeddings. Based on a determination that the requested information was found in the cold embeddings vector storage device (e.g., by finding cold embeddings (such as second embeddings) within the vector space that are proximate to the first search embeddings), the sequence flow 200 continues onto the process at operation 222. Based on a determination that the requested information was not found in the cold embeddings vector storage device (e.g., by finding no cold embeddings within the vector space that are proximate to the first search embeddings), the sequence flow 200 continues onto the process at operation 226. At operation 222, the computing system receives the second embeddings from the cold embeddings vector storage device, and converts the second embeddings into second data (at operation 224). The sequence flow 200 either continues onto the process at operation 232 or continues onto the process at operation 234 in FIG. 2B following the circular marker denoted, “A.”

At operation 226, the computing system (in some cases, using an AI agent, such as AI agent 106 of FIG. 1, or the like)) generates a first prompt for a private LLM (e.g., private LLM 114 of FIG. 1, or the like) to provide a summary of data. The computing system sends the first prompt to the private LLM (at operation 228), and receives the summary from the private LLM (at operation 230). The sequence flow 200 continues onto the process at operation 232. At operation 232, the computing system presents at least one of the first data, the second data, and/or the summary of data to the requesting device, in some cases, via a UI (e.g., UI 160 of FIG. 1, or the like). The sequence flow 200 continues onto the process at operation 234 in FIG. 2B following the circular marker denoted, “A.”

At operation 234 in FIG. 2B (following the circular marker denoted, “A,” in FIG. 2A), the computing system determines which portion(s) of data (e.g., the first data, the second data, and/or the data that is the basis of the summary of data) is likely to be used within the next X period (e.g., within the next one or more weeks, within the next one or more months, within the next annual quarter, within the next half a year, within the next year, or longer). Herein, likelihood of being used may refer to a probability exceeding a first threshold probability of being used (e.g., 50, 60, 70, 80%, or greater). In examples, the next X period (which may correspond to a project duration plus a buffer period following the project duration) may differ depending on the type of type of project associated with provisioning or building the first network service, or the like.

For portions of the data being likely to be used within the next X period (such as the next six months, for instance) [referred to in this example as “third data”], the computing system, at operation 236, identifies differences between the third data and the first data (which may correspond to the first embeddings received from the hot embeddings vector storage device). If there are differences, the sequence flow 200 continues onto the process at operation 238. If there are no differences, the sequence flow 200 returns to the process at operation 202 in FIG. 2A following the circular marker denoted, “B.” At operation 238, the computing system divides the third data or the differences into one or more portions of fifth data, in some cases, based on one or more of sentences, paragraphs, pages, documents, subject, topic, or relevance to the network service. The computing system converts each portion of the fifth data into one or more third embeddings (at operation 240), and stores the one or more third embeddings in the hot embeddings vector storage device (at operation 242).

Due to a potentially large number and/or size of documents, files, etc., and a limited number of tokens of LLMs (or limited context window size, such as about 4,000 tokens, about 8,000 tokens, or about 10,000), dividing (or extracting) relevant portions enables relevant and accurate searching by LLMs, while accounting for functional limitations of LLMs. As used herein, a token refers to a basic unit of text, audio, image, video, etc. that can be processed and understood, while context windows are the maximum number of tokens that can be processed at once. For instance, a large number of documents (e.g., dozens, hundreds, or thousands of documents, or more), a large number of pages of documents (e.g., dozens, hundreds, or thousands of pages, or more), a large number or file size of image, audio, and/or video data files (e.g., dozens, hundreds, thousands, tens of thousands, hundreds of thousands of data files, or more, some of which having large file sizes from tens, hundreds, thousands, tens of thousands, hundreds of thousands of megabytes (“MBs”), or more) may be determined to be relevant to the requested information (in this case, information regarding ordering of a network service, or information regarding network service in general, such as described below with respect to FIGS. 3A-3E and 4A-4C, or the like). In such a case, relevant or related portions may be divided or extracted from other portions of the data to produce meaningful portions (sometimes referred to as chunks in a process referred to as “chunking”) in the form of relevant or meaningful sentences, paragraphs, pages, portions of documents, or other forms or excerpts, etc. In this manner, a semantic index may be produced. Due to computational and other costs involved with producing a semantic index, an initial step may involve scanning all data that is accessible, and generating the semantic index, then maintaining up-to-date data based on any changes in the data (i.e., keeping the embeddings “hot” within the hot embeddings vector storage device). In other cases, non-relevant or non-related portions are either ignored, discarded, or stored as with the original documents in a low-priority, low-cost, long-term storage device; alternatively, such other portions may be converted to embeddings for storage in the hot embeddings vector storage device and/or the cold embeddings vector storage device based on a determination as to their likelihood of being used within the next X period.

In some examples, the one or more portions of the fifth data that are relevant are converted into the corresponding ones of the third embeddings (at operation 240), which are then stored in the hot embeddings vector storage device (at operation 242), while non-relevant or filler portions are either not converted into embeddings and/or not stored in the hot embeddings vector storage device, to reserve resources (e.g., conversion resources and storage resources) for relevant data. The sequence flow 200 either returns (after a second period has elapsed (e.g., after one or more hours, after one or more days, after one or more weeks, etc.)) to the process at operation 234 or returns to the process at operation 202 in FIG. 2A following the circular marker denoted, “B,” (and waits to receive the next request).

For portions of the data being not likely to be used within the next X period (such as the next six months, for instance) [referred to in this example as “fourth data”], the computing system, at operation 244, identifies differences between the fourth data and the second data (which may correspond to the second embeddings received from the cold embeddings vector storage device). If there are differences, the sequence flow 200 continues onto the process at operation 246. If there are no differences, the sequence flow 200 returns to the process at operation 202 in FIG. 2A following the circular marker denoted, “B.” At operation 246, the computing system divides the fourth data or the differences into one or more portions of sixth data, in some cases, based on one or more of sentences, paragraphs, pages, documents, subject, topic, or relevance to the network service. The computing system converts each portion of the sixth data into one or more fourth embeddings (at operation 248), and stores the one or more fourth embeddings in the cold embeddings vector storage device (at operation 250). In some examples, the one or more portions of the sixth data that are relevant are converted into the corresponding ones of the fourth embeddings (at operation 248), which are then stored in the cold embeddings vector storage device (at operation 250), while non-relevant or filler portions are either not converted into embeddings and/or not stored in the cold embeddings vector storage device, to reserve resources (e.g., conversion resources and storage resources) for relevant data. The sequence flow 200 either returns (after a second period has elapsed (e.g., after one or more hours, after one or more days, after one or more weeks, etc.)) to the process at operation 234 or returns to the process at operation 202 in FIG. 2A following the circular marker denoted, “B,” (and waits to receive the next request).

Turning to FIG. 2C, an example network service order summary 200A is shown. In the non-limiting example of FIG. 2C, a summary 260 is depicted, and may be in the form of one of a window in a UI (e.g., UI 160 of FIG. 1, or the like), a document, a file, a message (e.g., an email message, a text message, a short message service (“SMS”) message, a multimedia messaging service (“MMS”) message, etc.), or other format. The summary 260 is generated, in response to a prompt such as “provide me with a summary of this order,” by a private LLM (e.g., private LLM 114 of FIG. 1, or the like), by extracting information compiled from a plurality of data including at least one of textual data, message data, image data, audio data, video data, document data, or data files (e.g., JSON files, or the like), which may collectively have a cumulative size that exceeds a token size of the private LLM. In examples, the summary 260 may include at least one order information, including order number(s), passive optical network (“PON”) component identifier(s), customer request date, commitment date, access service request (“ASR”) start date, firm order commitment (“FOC”) date, vendor equipment receipt date, design layout report date (“DLRD”), billing account number (“BAN”), order status, details regarding order status, milestone information, summary of notes, status of third party contributors to provisioning of the network service, information regarding technical issues, information regarding potential delays, status of necessary permit requests, information regarding required equipment, or estimated service data, and/or the like.

In FIG. 2C, “*” represents redacted information, for the purposes of simplicity of illustration in this patent document, but would be visible to a user receiving a summary generated by the private LLM (unless otherwise indicated). Although FIGS. 2A-2C are directed to ordering of a network service, and although FIG. 2C depicts an example order summary, other aspects of a network service may be the subject of queries to the computing system and/or the private LLM, and the corresponding summary would be directed to these other aspects.

FIGS. 3A-3E (collectively, “FIG. 3”) depict flow diagrams illustrating an example method 300 for implementing data storage and search functionality using hot and cold embeddings, in accordance with various embodiments. In examples, the operations of example method 300 may be performed by a computing system (e.g., computing system 104 of FIG. 1 (or its components)).

In the non-limiting embodiment of FIG. 3A, method 300, at operation 302, may include a computing system receiving, from a requesting device (e.g., requesting device(s) 158 of FIG. 1, or the like), a first request for information regarding a first network service (e.g., one of the plurality of network services 148a-148z of FIG. 1, or the like) that is one of being provisioned, in a process of being provisioned, or being ordered for provisioning, by a service provider, at one or more locations (e.g., location(s) 136 of FIG. 1, or the like) associated with a first entity. At operation 304, the computing system queries a first vector data storage device (e.g., the first vector data storage device 116 of FIG. 1, or the like) for stored information regarding the first network service, based on the first request. The first vector data storage device stores a plurality of hot embeddings (e.g., hot embeddings 118a-118n of FIG. 1, or the like). The plurality of hot embeddings includes vector representations of a corresponding plurality of data (e.g., such as some portion(s) of data 128, 130, 140, and/or 142, or event data 154 of FIG. 1, or the like) that each has a probability exceeding a first threshold probability (e.g., 50, 60, 70, 80%, or greater) of being used within a succeeding timeframe (e.g., within the next one or more weeks, within the next one or more months, within the next annual quarter, within the next half a year, within the next year, or longer). The plurality of hot embeddings is associated with a plurality of network services (e.g., the plurality of network services 148a-148z of FIG. 1, or the like) each of which is one of being provisioned, in a process of being provisioned, or being ordered for provisioning, by the service provider, at a plurality of locations associated with a corresponding plurality of entities.

At operation 306, the computing system determines whether embeddings corresponding to the requested information have been found in the first vector data storage device. Based on a determination that embeddings corresponding to the requested information have been found in the first vector data storage device, method 300 continues onto the process at operation 308, at which the computing system performs a first set of tasks. Based on a determination that embeddings corresponding to the requested information have not been found in the first vector data storage device, method 300 continues onto the process at operation 316, at which the computing system performs a second set of tasks. Following performance of the first set of tasks (at operation 308) or the second set of tasks (at operation 316), method 300 may continue onto one of the process at operation 344 in FIG. 3C following the circular marker denoted, “A,” the process at operation 348 in FIG. 3D following the circular marker denoted, “B,” or the process at operation 366 in FIG. 3E following the circular marker denoted, “C.”

In examples, performing the first set of tasks (at operation 308) may include the computing system receiving, from the first vector data storage device, first embeddings corresponding to vector representations of first data that are associated with the first network service (at operation 310); converting the first embeddings into second data (at operation 312); and sending the second data to the requesting device (at operation 314). In some examples, the first data may include at least one of textual data, message data, image data, audio data, video data, document data, or data files (e.g., JSON files, or the like), and/or the like. In examples, the first data may further include data that is associated with at least one of:
(a) ordering of the first network service by the first entity;
(b) communicating with the first entity regarding the first network service;
(c) provisioning of the first network service;
(d) building infrastructure for provisioning the first network service;
(e) obtaining permits for provisioning of the first network service;
(f) obtaining permits for building the infrastructure for provisioning the first network service;
(g) communicating with local authorities regarding the first network service; or
(h) communicating with local authorities regarding building the infrastructure for provisioning the first network service; and/or the like.

In some cases, the first data further includes at least one of:
(1) a status of the first network service;
(2) a status of provisioning of the first network service;
(3) a status of building the infrastructure for provisioning the first network service;
(4) a snapshot of information regarding the first network service;
(5) historical information regarding the first network service;
(6) notes regarding provisioning of the first network service;
(7) notes regarding building infrastructure for provisioning the first network service;
(8) notes regarding obtaining permits for provisioning of the first network service;
(9) notes regarding obtaining permits for building infrastructure for provisioning the first network service;
(10) notes regarding communicating with local authorities regarding the first network service;
(11) notes regarding communicating with local authorities regarding building the infrastructure for provisioning the first network service;
(12) information regarding payment for the first network service;
(13) information regarding the first entity with which the first network service is associated; or
(14) information regarding an account associated with the first entity; and/or the like.

In some examples, the second data either includes at least a portion of the first data or is in a format corresponding to a format of at least a portion of the first data. In examples, the second data may include at least one of a summary of the first data, a report containing information extracted from the first data, a curated collection of the first data, or an ordered compilation of the first data, and/or the like.

In examples, performing the second set of tasks (at operation 316) includes the computing system receiving, from the first vector data storage device, a first message indicating that information regarding the first network service could not be found (at operation 318); generating a first prompt for a private LLM (e.g., private LLM 114 of FIG. 1, or the like) to provide a summary of data regarding the first network service that is accessed from two or more data storage devices among a plurality of data storage devices in at least one network (at operation 320), the first prompt being generated based on the first request; sending the first prompt as input to the private LLM (at operation 322); receiving the summary from the private LLM (at operation 324); and sending the summary to the requesting device (at operation 326).

At operation 328, the computing system queries, via a cold storage processor of the computing system (e.g., cold storage processor 108 of FIG. 1, or the like), a second vector data storage device (e.g., the second vector data storage device 120 of FIG. 1, or the like), based on a second request. The second request may include at least one of a request for historical data, a request for trending data, a request for audit-related data, or a request for related data associated with the first network service, and/or the like. At operation 330, the computing system receives, from the second vector data storage device, second embeddings corresponding to vector representations of third data, the third data including at least one of historical data, trending data, audit-related data, or related data associated with the first network service. At operation 332, the computing system converts the third embeddings into fourth data, the fourth data either including at least a portion of the third data or being in a format corresponding to a format of at least a portion of the third data. At operation 334, the computing system sends the fourth data to the requesting device, in some cases, together with the second data (such as at operation 314).

With reference to FIG. 3B, converting the first embeddings into second data (at operation 312) includes the computing system converting the first embeddings into the first data (at operation 336); generating a second prompt for the private LLM to convert the first data into the second data (at operation 338); sending the second prompt as input to the private LLM (at operation 340); and receiving the second data from the private LLM (at operation 342). In some examples, the first and second prompts may be generated using an AI agent (e.g., AI agent 106 of FIG. 1, or the like).

At operation 344 in FIG. 3C (following the circular marker denoted, “A,” in FIG. 3A), method 300 may include the cold storage processor of the computing system identifying third embeddings stored in the first vector data storage device that correspond to data that is determined to be at least one of no longer used, not frequently used, not likely to be used, no longer current, or no longer up-to-date and that is associated with a second network service among the plurality of network services. In examples, determining that the data corresponding to the second embeddings are at least one of no longer used, not frequently used, not likely to be used, no longer current, or no longer up-to-date may be based on one or more of a generation date corresponding to a date on which the second embeddings were generated, a modified date corresponding to a date on which the second embeddings were modified, or a project duration corresponding to a type of project associated with provisioning or building the second network service, and/or the like. At operation 346, the cold storage processor moves the third embeddings to the second vector data storage device for long-term storage.

At operation 348 in FIG. 3D (following the circular marker denoted, “B,” in FIG. 3A), method 300 may include the computing system receiving, from at least one event listener (e.g., event listener(s) 156 of FIG. 1, or the like), event data that is collected by the at least one event listener. In some examples, the event data may include updated data associated with at least one of the first network service, provisioning of the first network service, building infrastructure for provisioning the first network service, or an account associated with the first entity, and/or the like. At operation 350, the computing system may update the first embeddings based on the updated data. In an example, updating the first embeddings based on the updated data (at operation 350) may include the computing system converting the updated data into fourth embeddings (at operation 352); and replacing at least a portion of the first embeddings corresponding to the updated data with the fourth embeddings (at operation 354). Alternatively or additionally, in another example, updating the first embeddings based on the updated data (at operation 350) may include the computing system identifying a difference between the first data and the updated data (at operation 356); converting the first embeddings into the first data (at operation 358); updating the first data with the difference to produce fifth data (at operation 360); converting the fifth data into fifth embeddings (at operation 362); and storing the fifth embeddings in the first vector data storage device (at operation 364); and/or the like.

At operation 366 in FIG. 3E (following the circular marker denoted, “C,” in FIG. 3A), method 300 may include the computing system determining whether a portion of the first data that was retrieved from the two or more data storage devices has changed, by retrieving the first embeddings from the first vector data storage device (at operation 368); converting the first embeddings into the first data (at operation 370); retrieving sixth data from the two or more data storage devices (at operation 372), the sixth data corresponding to at least one of a version or a portion of the first data; and comparing a hash code of the portion of first data with a hash code of a portion of sixth data (at operation 374), a difference in hash codes being indicative of a change in the first data. Based on a determination that the portion of the first data has changed, the computing system converts the sixth data into sixth embeddings (at operation 376); and replaces the first embeddings that are stored in the first vector data storage device with the sixth embeddings (at operation 378).

FIGS. 4A-4C (collectively, “FIG. 4”) depict flow diagrams illustrating another example method 400 for implementing data storage and search functionality using hot and cold embeddings, in accordance with various embodiments. In examples, the operations of example method 400 may be performed by a computing system (e.g., computing system 104 of FIG. 1 (or its components)).

In the non-limiting embodiment of FIG. 4A, method 400, at operation 405, may include a computing system receiving, from two or more data storage devices among a plurality of data storage devices (e.g., data storage devices 126a-126x and 138a-138y of FIG. 1, or the like) in at least one network (e.g., networks 134, 146, and 150 of FIG. 1, or the like), first data associated with a first network service (e.g., one of the plurality of network services 148a-148z of FIG. 1, or the like) that is one of being provisioned, in a process of being provisioned, or being ordered for provisioning, by a service provider, at one or more premises locations (e.g., location(s) 136 of FIG. 1, or the like) associated with a first entity. In examples, the first data may include at least one of textual data, message data, image data, audio data, video data, document data, or data files (e.g., JSON files, or the like) collectively having a cumulative size that exceeds a token size of a private LLM (e.g., private LLM 114 of FIG. 1, or the like).

At operation 410, the computing system divides at least portions of the first data, in some cases, based on one or more of sentences, paragraphs, pages, documents, subject, topic, or relevance to the first network service to produce a plurality of second data. At operation 415, the computing system identifies second data, among the first data (in some cases, among at least portions of the first data that are determined to be relevant or related to the first network service), that has a probability exceeding a first threshold probability of being used (e.g., 50, 60, 70, 80%, or greater) within a succeeding timeframe (e.g., within the next one or more weeks, within the next one or more months, within the next annual quarter, within the next half a year, within the next year, or longer).

At operation 420, the computing system converts one or more portions of the second data into a corresponding one or more first embeddings each corresponding to a vector representation of one of the one or more portions of the second data. At operation 425, the computing system stores, in a first vector data storage device (e.g., the first vector data storage device 116 of FIG. 1, or the like), the one or more first embeddings as a first set of hot embeddings among a plurality of hot embeddings (e.g., hot embeddings 118a-118n of FIG. 1, or the like) stored in the first vector data storage device. Method 400 may continue onto one of the process at operation 430, the process at operation 435 in FIG. 4B following the circular marker denoted, “A,” or the process at operation 455 in FIG. 4C following the circular marker denoted, “B.”

At operation 430, in response to receiving a request for information regarding the first data, the computing system queries the first vector data storage device for the first set of hot embeddings, prior to attempts at generating and sending a prompt as input to the private LLM to produce data regarding the first network service accessed from the two or more data storage devices. Method 400 either may continue onto the process at operation 435 in FIG. 4B following the circular marker denoted, “A,” or may continue onto the process at operation 455 in FIG. 4C following the circular marker denoted, “B.”

At operation 435 in FIG. 4B (following the circular marker denoted, “A,” in FIG. 4A), method 400 may include the computing system identifying third data, among the first data, that has a probability falling below the first threshold probability of being used within the succeeding timeframe. In examples, identifying the third data (at operation 435) may include determining that the third data is at least one of no longer used, not frequently used, not likely to be used, no longer current, or no longer up-to-date, based on one or more of a generation date corresponding to a date on which the third data was generated, a modified date corresponding to a date on which the third data was modified, or a project duration corresponding to a type of project associated with provisioning or building the first network service, and/or the like.

At operation 440, the computing system converts one or more portions of the third data into a corresponding one or more second embeddings each corresponding to a vector representation of one of the one or more portions of the third data. At operation 445, the computing system stores, in a second vector data storage device (e.g., the second vector data storage device 120 of FIG. 1, or the like), the one or more second embeddings as a first set of cold embeddings among a plurality of cold embeddings (e.g., cold embeddings 122a-122m of FIG. 1, or the like) stored in the second vector data storage device. At operation 450, in response to receiving at least one of a request for historical data, a request for trending data, a request for audit-related data, or a request for related data associated with the first network service, the computing system queries the second vector data storage device for the first set of cold embeddings.

At operation 455 in FIG. 4C (following the circular marker denoted, “B,” in FIG. 4A), method 400 may include a cold storage processor of the computing system (e.g., cold storage processor 108 of FIG. 1, or the like) identifying one or more third embeddings, among the plurality of hot embeddings stored in the first vector data storage device, that correspond to fourth data that is determined to be at least one of no longer used, not frequently used, not likely to be used, no longer current, or no longer up-to-date, the one or more third embeddings corresponding to a second network service (e.g., another one of the plurality of network services 148a-148z of FIG. 1, or the like). In some examples, determining that the fourth data corresponding to the one or more third embeddings is at least one of no longer used, not frequently used, not likely to be used, no longer current, or no longer up-to-date (as a precursor of operation 455) may be based on one or more of a generation date corresponding to a date on which the one or more third embeddings were generated, a generation date corresponding to a date on which the fourth data was generated, a modified date corresponding to a date on which the one or more third embeddings were modified, a modified date corresponding to a date on which the fourth data was modified, or a project duration corresponding to a type of project associated with provisioning or building the second network service, and/or the like. At operation 460, the cold storage processor moves the one or more third embeddings to the second vector data storage device for long-term storage as a second set of cold embeddings.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100, 200, and 200A of FIGS. 1, 2A-2B, and 2C, respectively (or components thereof), such methods may also be implemented using any suitable hardware (or software) implementation. Similarly, while each of the systems, examples, or embodiments 100, 200, and 200A of FIGS. 1, 2A-2B, and 2C, respectively (or components thereof), can operate according to the methods 300, 400 (e.g., by executing instructions embodied on a computer readable medium), the systems, examples, or embodiments 100, 200, and 200A of FIGS. 1, 2A-2B, and 2C can each also operate according to other modes of operation and/or perform other suitable procedures.

### Exemplary System and Hardware Implementation

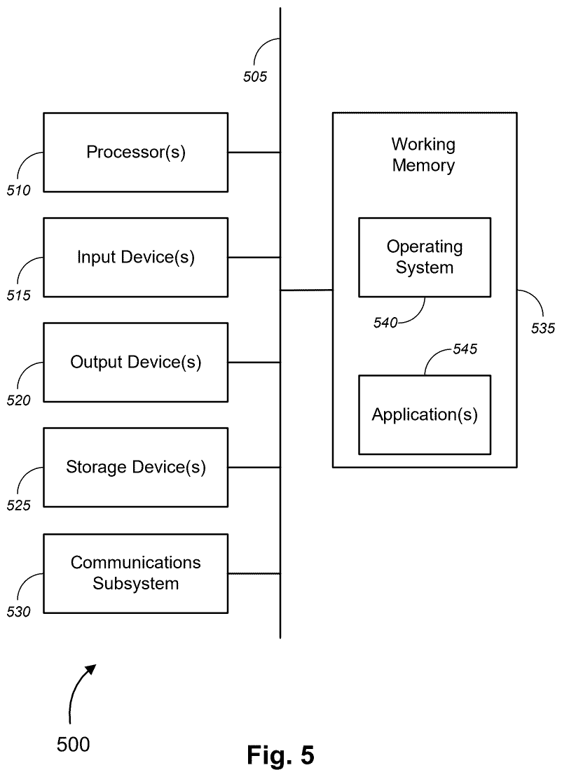

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., query management system 102, computing system 104, AI agent 106, cold storage processor 108, synchronization processor 110, AI system 112, monitoring system(s) 152, and requesting device(s) 158, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., query management system 102, computing system 104, AI agent 106, cold storage processor 108, synchronization processor 110, AI system 112, monitoring system(s) 152, and requesting device(s) 158, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system and from a requesting device, a first request for information regarding a first network service that is one of being provisioned, in a process of being provisioned, or being ordered for provisioning, by a service provider, at one or more locations associated with a first entity;
querying, by the computing system, a first vector data storage device for stored information regarding the first network service, based on the first request, the first vector data storage device storing a plurality of hot embeddings, the plurality of hot embeddings being vector representations of a corresponding plurality of data that each has a probability exceeding a first threshold probability of being used within a succeeding timeframe and that is associated with a plurality of network services each of which is one of being provisioned, in a process of being provisioned, or being ordered for provisioning, by the service provider, at a plurality of locations associated with a corresponding plurality of entities; and
performing, by the computing system, one of:
a first set of tasks including:
receiving, from the first vector data storage device, first embeddings corresponding to vector representations of first data that are associated with the first network service;
converting the first embeddings into second data; and
sending the second data to the requesting device, the second data either including at least a portion of the first data or being in a format corresponding to a format of at least a portion of the first data; or
a second set of tasks including:
receiving, from the first vector data storage device, a first message indicating that information regarding the first network service could not be found;
generating a first prompt for a private large language model (“LLM”) to provide a summary of data regarding the first network service that is accessed from two or more data storage devices among a plurality of data storage devices in at least one network, the first prompt being generated based on the first request;
sending the first prompt as input to the private LLM;
receiving the summary from the private LLM; and
sending the summary to the requesting device.

2. The method of claim 1, wherein the first data includes at least one of textual data, message data, image data, audio data, video data, document data, or data files, wherein the second data includes at least one of a summary of the first data, a report containing information extracted from the first data, a curated collection of the first data, or an ordered compilation of the first data,
wherein the first data further includes data that is associated with at least one of:
ordering of the first network service by the first entity;
communicating with the first entity regarding the first network service;
provisioning of the first network service;
building infrastructure for provisioning the first network service;
obtaining permits for provisioning of the first network service;
obtaining permits for building the infrastructure for provisioning the first network service;
communicating with local authorities regarding the first network service; or
communicating with local authorities regarding building the infrastructure for provisioning the first network service.

3. The method of claim 2, wherein the first data further includes at least one of:
a status of the first network service;
a status of provisioning of the first network service;
a status of building the infrastructure for provisioning the first network service;
a snapshot of information regarding the first network service;
historical information regarding the first network service;
notes regarding provisioning of the first network service;
notes regarding building infrastructure for provisioning the first network service;
notes regarding obtaining permits for provisioning of the first network service;
notes regarding obtaining permits for building infrastructure for provisioning the first network service;
notes regarding communicating with local authorities regarding the first network service;
notes regarding communicating with local authorities regarding building the infrastructure for provisioning the first network service;
information regarding payment for the first network service;
information regarding the first entity with which the first network service is associated; or
information regarding an account associated with the first entity.

4. The method of claim 2, wherein converting the first embeddings into second data comprises:
converting, by the computing system, the first embeddings into the first data;
generating, by the computing system, a second prompt for the private LLM to convert the first data into the second data;
sending, by the computing system, the second prompt as input to the private LLM; and
receiving, by the computing system, the second data from the private LLM.

5. The method of claim 1, wherein the first vector data storage device includes a retrieval augmented generation (“RAG”) data storage system that is a long-term, persisting, cache-like vector database, wherein the plurality of data that is stored as the plurality of hot embeddings include vector representations of portions of textual data, message data, image data, audio data, video data, document data, or data files associated with the plurality of network services that are divided based on one or more of sentences, paragraphs, pages, documents, subject, topic, or relevance to one of the plurality of network services.

6. The method of claim 1, further comprising:
identifying, by a cold storage processor of the computing system, second embeddings stored in the first vector data storage device that correspond to data that is determined to be at least one of no longer used, not frequently used, not likely to be used, no longer current, or no longer up-to-date and that is associated with a second network service among the plurality of network services; and
moving, by the cold storage processor, the second embeddings to a second vector data storage device for long-term storage.

7. The method of claim 6, wherein determining that the data corresponding to the second embeddings are at least one of no longer used, not frequently used, not likely to be used, no longer current, or no longer up-to-date is based on one or more of a generation date corresponding to a date on which the second embeddings were generated, a modified date corresponding to a date on which the second embeddings were modified, or a project duration corresponding to a type of project associated with provisioning or building the second network service.

8. The method of claim 6, wherein the first request includes a second request including at least one of a request for historical data, a request for trending data, a request for audit-related data, or a request for related data associated with the first network service, wherein the method further comprises:
querying, by the computing system and via the cold storage processor, the second vector data storage device, based on the second request;
wherein the first set of tasks further includes:
receiving, from the second vector data storage device, third embeddings corresponding to vector representations of third data, the third data including at least one of historical data, trending data, audit-related data, or related data associated with the first network service; and
converting the third embeddings into fourth data, the fourth data either including at least a portion of the third data or being in a format corresponding to a format of at least a portion of the third data;
wherein sending the second data includes sending the fourth data together with the second data to the requesting device.

9. The method of claim 1, further comprising:
receiving, by the computing system and from at least one event listener, event data that is collected by the at least one event listener, the event data including updated data associated with at least one of the first network service, provisioning of the first network service, building infrastructure for provisioning the first network service, or an account associated with the first entity; and
updating, by the computing system, the first embeddings based on the updated data.

10. The method of claim 9, wherein updating the first embeddings based on the updated data comprises one of:
converting, by the computing system, the updated data into fourth embeddings, and replacing, by the computing system, at least a portion of the first embeddings corresponding to the updated data with the fourth embeddings; or
identifying, by the computing system, a difference between the first data and the updated data, converting, by the computing system, the first embeddings into the first data, updating, by the computing system, the first data with the difference to produce fifth data, converting, by the computing system, the fifth data into fifth embeddings, and storing, by the computing system, the fifth embeddings in the first vector data storage device.

11. The method of claim 1, further comprising:
determining, by the computing system, whether a portion of the first data that was retrieved from the two or more data storage devices has changed, by:
retrieving, by the computing system, the first embeddings from the first vector data storage device;
converting, by the computing system, the first embeddings into the first data;
retrieving, by the computing system, sixth data from the two or more data storage devices, the sixth data corresponding to at least one of a version or a portion of the first data;
comparing, by the computing system, a hash code of the portion of first data with a hash code of a portion of sixth data, a difference in hash codes being indicative of a change in the first data; and
based on a determination that the portion of the first data has changed, converting, by the computing system, the sixth data into sixth embeddings, and replacing, by the computing system, the first embeddings that are stored in the first vector data storage device with the sixth embeddings.

12. A system, comprising:
a processing system; and
memory coupled to the processing system, the memory comprising computer executable instructions that, when executed by the processing system, causes the system to perform operations comprising:
receiving, from a requesting device, a first request for information regarding a first network service that is one of being provisioned, in a process of being provisioned, or being ordered for provisioning, by a service provider, at one or more locations associated with a first entity;
querying a first vector data storage device for stored information regarding the first network service, based on the first request, the first vector data storage device storing a plurality of hot embeddings, the plurality of hot embeddings being vector representations of a corresponding plurality of data that each has a probability exceeding a first threshold probability of being used within a succeeding timeframe and that is associated with a plurality of network services each of which is one of being provisioned, in a process of being provisioned, or being ordered for provisioning, by the service provider, at a plurality of locations associated with a corresponding plurality of entities; and
performing one of:
a first set of tasks including:
receiving, from the first vector data storage device, first embeddings corresponding to vector representations of first data that are associated with the first network service;
converting the first embeddings into second data; and
sending the second data to the requesting device, the second data either including at least a portion of the first data or being in a format corresponding to a format of at least a portion of the first data; or
a second set of tasks including:
receiving, from the first vector data storage device, a first message indicating that information regarding the first network service could not be found;
generating a prompt for a private large language model (“LLM”) to access third data regarding the first network service from two or more data storage devices among a plurality of data storage devices in at least one network and to convert the third data into fourth data, the prompt being generated based on the first request;
sending the prompt as input to the private LLM;
receiving the fourth data from the private LLM; and
sending the fourth data to the requesting device.

13. The system of claim 12, wherein the first data and the third data each includes at least one of textual data, message data, image data, audio data, video data, document data, or data files, wherein the second data includes at least one of a summary of the first data, a report containing information extracted from the first data, a curated collection of the first data, or an ordered compilation of the first data, wherein the fourth data includes at least one of a summary of the third data, a report containing information extracted from the third data, a curated collection of the third data, or an ordered compilation of the third data.

14. The system of claim 12, wherein the first vector data storage device includes a retrieval augmented generation (“RAG”) data storage system that is a long-term, persisting, cache-like vector database, wherein the data that is stored as the plurality of hot embeddings include portions of textual data, message data, image data, audio data, video data, document data, or data files associated with the plurality of network services that are divided based on one or more of sentences, paragraphs, pages, documents, subject, topic, or relevance to one of the plurality of network services.

15. The system of claim 12, wherein the operations further comprise:
identifying second embeddings stored in the first vector data storage device that correspond to data that is determined to be at least one of no longer used, not frequently used, not likely to be used, no longer current, or no longer up-to-date and that is associated with a second network service among the plurality of network services; and
moving the second embeddings to a second vector data storage device for long-term storage.

16. A method, comprising:
receiving, by a computing system and from two or more data storage devices among a plurality of data storage devices in at least one network, first data associated with a first network service that is one of being provisioned, in a process of being provisioned, or being ordered for provisioning, by a service provider, at one or more premises locations associated with a first entity, the first data including at least one of textual data, message data, image data, audio data, video data, document data, or data files collectively having a cumulative size that exceeds a token size of a private large language model (“LLM”);
dividing, by the computing system, at least portions of the first data based on one or more of sentences, paragraphs, pages, documents, subject, topic, or relevance to the first network service to produce a plurality of second data;
identifying, by the computing system, second data, among the first data, that has a probability exceeding a first threshold probability of being used within a succeeding timeframe;
converting, by the computing system, one or more portions of the second data into a corresponding one or more first embeddings each corresponding to a vector representation of one of the one or more portions of the second data; and
storing, by the computing system and in a first vector data storage device, the one or more first embeddings as a first set of hot embeddings among a plurality of hot embeddings stored in the first vector data storage device;
wherein, in response to receiving a request for information regarding the first data, the computing system queries the first vector data storage device for the first set of hot embeddings, prior to attempts at generating and sending a prompt as input to the private LLM to produce data regarding the first network service accessed from the two or more data storage devices.

17. The method of claim 16, further comprising:
identifying, by the computing system, third data, among the first data, that has a probability falling below the first threshold probability of being used within the succeeding timeframe;
converting, by the computing system, one or more portions of the third data into a corresponding one or more second embeddings each corresponding to a vector representation of one of the one or more portions of the third data; and
storing, by the computing system and in a second vector data storage device, the one or more second embeddings as a first set of cold embeddings among a plurality of cold embeddings stored in the second vector data storage device;
wherein, in response to receiving at least one of a request for historical data, a request for trending data, a request for audit-related data, or a request for related data associated with the first network service, the computing system queries the second vector data storage device for the first set of cold embeddings.

18. The method of claim 17, wherein identifying the third data includes determining that the third data is at least one of no longer used, not frequently used, not likely to be used, no longer current, or no longer up-to-date, based on one or more of a generation date corresponding to a date on which the third data was generated, a modified date corresponding to a date on which the third data was modified, or a project duration corresponding to a type of project associated with provisioning or building the first network service.

19. The method of claim 17, further comprising:
identifying, by a cold storage processor of the computing system, one or more third embeddings, among the plurality of hot embeddings stored in the first vector data storage device, that correspond to fourth data that is determined to be at least one of no longer used, not frequently used, not likely to be used, no longer current, or no longer up-to-date, the one or more third embeddings corresponding to a second network service; and
moving, by the cold storage processor, the one or more third embeddings to the second vector data storage device for long-term storage as a second set of cold embeddings.

20. The method of claim 19, wherein determining that the fourth data corresponding to the one or more third embeddings is at least one of no longer used, not frequently used, not likely to be used, no longer current, or no longer up-to-date is based on one or more of a generation date corresponding to a date on which the one or more third embeddings were generated, a generation date corresponding to a date on which the fourth data was generated, a modified date corresponding to a date on which the one or more third embeddings were modified, a modified date corresponding to a date on which the fourth data was modified, or a project duration corresponding to a type of project associated with provisioning or building the second network service.
